(19) United States
(12) Patent Application Publication
(10) Pub. No.: US 2019/0339500 A1
(43) Pub. Date: Nov. 7, 2019

(54) OPTICAL ARRANGEMENT FOR PULSED ILLUMINATION, METHOD FOR PULSED ILLUMINATION AND MICROSCOPE

(71) Applicant: LEICA MICROSYSTEMS CMS GMBH, Wetzlar (DE)

(72) Inventors: Bernd WIDZGOWSKI, Dossenheim (DE); Vishnu Vardhan KRISHNAMACHARI, Seeheim-Jugenheim (DE); Lars FRIEDRICH, Weinheim (DE); Manuel KREMER, Leimen (DE); Arnold GISKE, Sandhausen (DE)

(21) Appl. No.: 16/305,902

(22) PCT Filed: May 31, 2017
(86) PCT No.: PCT/EP2017/063216

§ 371 Date: Nov. 30, 2018

(30) Foreign Application Priority Data
May 31, 2016 (DE) 10 2016 110 067.6

(51) Int. Cl. G02B 21/00

(52) U.S. Cl. CPC G02B 21/0032; G02F 1/116; G02B 21/0076

(57) ABSTRACT

An optical arrangement has an optical beam path for illuminating a sample space with a sequence of laser light pulses generated in a laser cycle, the optical arrangement. At least one laser light source is configured to generate the sequence of laser light pulses along the optical beam path. A wavelength-selective pulse picker is situated in the optical beam path and has, in a predefined illumination clock timing synchronizable with the laser light pulses, an open state in which the pulse picker is light-transparent to at least one laser light pulse towards the sample space. The open state has at least two different transmission states which differ with regard to their respective transmission spectrums, and wherein the two transmission states are switchable on and/or off independently of one another.

### CROSS-REFERENCE TO PRIOR APPLICATIONS

This application is a U.S. National Stage Application under 35 U.S.C. § 371 of International Application No. PCT/EP2017/063216 filed on May 31, 2017, and claims benefit to German Patent Application No. DE 10 2016 110 067.6 filed on May 31, 2016. The International Application was published in German on Dec. 7, 2017, as WO 2017/207664 A1 under PCT Article 21(2).

### FIELD

The invention relates to an optical arrangement for illuminating a sample space with a sequence of laser light pulses generated in a laser cycle, a microscope, and a method for illuminating a sample space with a sequence of laser light pulses.

### BACKGROUND

Although optical arrangements known from the prior art allow the pulse repetition frequency, which corresponds to the laser cycle, of the generated pulses to be reduced, they are cost-intensive, can reduce the stability of the laser light source, and cannot be adapted to every illumination situation.

An optical arrangement with which this can be achieved is described in, for example, EP 2 081 074 B1. There, a so-called pulse picker (German: Pulsselektor) is arranged between a mode-locked fiber oscillator and an optical fiber amplifier of a supercontinuum laser. The provision of the pulse picker at this position, i.e., in the supercontinuum laser, can be disadvantageous and entail additional costs.

### SUMMARY

In an embodiment, the present invention provides an optical arrangement having an optical beam path for illuminating a sample space with a sequence of laser light pulses generated in a laser cycle, the optical arrangement. At least one laser light source is configured to generate the sequence of laser light pulses along the optical beam path. A wavelength-selective pulse picker is situated in the optical beam path and has, in a predefined illumination clock timing synchronizable with the laser light pulses, an open state in which the pulse picker is light-transparent to at least one laser light pulse towards the sample space. The open state has at least two different transmission states which differ with regard to their respective transmission spectrums, and wherein the two transmission states are switchable on and/or off independently of one another.

### BRIEF DESCRIPTION OF THE DRAWING

The present invention will be described in even greater detail below based on the exemplary FIGURE. The invention is not limited to the exemplary embodiments. All features described and/or illustrated herein can be used alone or combined in different combinations in embodiments of the invention. The same technical features and technical features with the same technical effect are provided with the same reference numerals for the sake of clarity. The features and advantages of various embodiments of the present invention will become apparent by reading the following detailed description with reference to the attached drawing which illustrates the following:

FIG. 1 shows a schematic structure of the optical arrangement according to the invention in one possible embodiment.

### DETAILED DESCRIPTION

Embodiments of the present invention provide an optical arrangement, a microscope, and a method that are cost-effective, allow versatile illumination applications, and also do not influence the stability of a laser system.

Optical arrangements for illumination can be used, for example, in fluorescence microscopy—in particular, using confocal or light sheet microscopes. In these applications, pulsed lasers are used to excite dyes (luminophores or fluorophores) which have an afterglow after the excitation. The afterglow (luminescence or fluorescence) usually required excitation in a specific spectral range, i.e., at a specific wavelength. If several luminophores are used simultaneously, it is desirable to be able to differentiate the luminescence of different luminophores—particularly if they have a different temporal behavior of the luminescence. These difficulties are known and are solved in the prior art by means of, for example, individual lasers, which respectively excite one luminophore and are controlled separately.

The optical arrangement mentioned at the outset for illuminating a sample space with a sequence of laser light pulses generated in a laser cycle achieves the above aims in that the optical arrangement has an optical beam path, at least one laser light source for generating the sequence of laser light pulses along the optical beam path, and a wavelength-selective pulse picker situated in the optical beam path. The pulse picker has, in a predefined illumination clock timing synchronizable with the laser light pulses, an open state in which the pulse picker is transparent to at least one laser light pulse towards the sample space, wherein the open state has at least two different transmission states which differ with regard to their respective transmission spectrums, and wherein the two transmission states can be switched on and/or off independently of one another.

The microscope according to an embodiment of the invention—in particular, a PIE microscope—achieves the above aims with an optical arrangement according to an embodiment of the invention.

The method according to an embodiment of the invention mentioned at the outset achieves the above aims by sending the laser light pulses through a wavelength-selective pulse picker, which is switched between at least two different transmission spectra synchronously with the laser cycle.

Embodiments of the present invention thus differ from the previously known solutions, which do not allow a wavelength-selective reduction, synchronized with the laser light pulses, in the pulse repetition frequency.

Further embodiments of the invention are described below, the additional or alternative technical features of which are in each case advantageous by themselves and can be combined with one another as desired.

The laser light source used can emit light of several colors or wavelengths and may, preferably, be a supercontinuum laser or a Raman laser. The supercontinuum laser may have a pump light source and a non-linear fiber. A non-linear fiber is to be understood as a fiber in which non-linear optical effects, such as self-phase modulation, of the coupled laser pulses of the pump light source occur. The laser light source emits pulsed light with at least one laser light pulse or laser pulse.

The optical beam path is to be understood as an optical path along which the electromagnetic waves of the light, or, in the case of pulses, of the electromagnetic wave packet, propagate. The optical beam path is linear and may be changed using optical elements, such as mirrors, prisms, gratings, or the like. The optical beam path is essentially determined by the laser light source.

A transmission state is to be understood as a setting or mode of the optical arrangement. Each transmission state is characterized by a respective transmission spectrum, wherein the transmission spectra preferably have at least one transmission maximum. Different transmission states differ in their transmission spectra, wherein the transmission spectra of two different transmission states can be partially identical and may differ only in defined wavelength ranges.

Preferably, with the plurality of possible transmission states, the emission spectrum of the laser light source can be covered. In the case of a supercontinuum laser, all wavelengths of the visible spectrum or an entire octave, for example, can thus be covered. This means that different transmission states may have transmission maxima distributed across the emission spectrum of the laser light source, but wavelength ranges without a transmission maximum of a transmission state may also be present.

In one embodiment of the method, switching between the at least two different transmission spectra comprises the generation of a frequency sequence comprising at least one frequency and the application of the frequency sequence to a sound transducer, and toggling the frequency of the frequency sequence back and forth.

Since the open state can be synchronized with the laser cycle, it is thus ensured that a laser pulse in the pulse picker encounters a combination of transmission states which remains unchanged at least until the next illumination cycle, which can correspond to the next laser cycle.

The illumination cycle of the pulse picker can have a lower frequency than the laser cycle, so that illumination of the sample space is prevented between two cycles of the illumination clock; in other words, no laser light pulse is allowed to pass to the sample space. However, the illumination cycle can also correspond to the laser cycle, so that a laser light pulse can illuminate the sample space during every cycle of the laser clock.

The PIE microscope mentioned at the outset is to be understood as a microscope which excites a sample with interleaved, i.e., time-offset and time-interleaved, pulse sequences. With the microscope according to the invention, this so-called “pulsed interleaved excitation (PIE)” functionality, i.e., the excitation with interleaved pulses, which is used in an optical examination of a sample with a microscope—in particular, with a scanning microscope and, very particularly preferably, with a confocal scanning microscope—can, in a particularly advantageous manner, be realized in combination with a pulsed multicolor laser or several, mutually synchronized, pulsed multicolor lasers or a supercontinuum laser.

In a further embodiment of the optical arrangement, the pulse picker has at least three different transmission states which can be switched independently of one another. This has the advantage that three luminophores can be used in the sample, wherein the different transmission spectra of the three, independently-switchable transmission states can essentially correspond to the excitation spectra of the luminophores.

Thus, the three luminophores can be excited at any time in the illumination cycle, wherein any combination of the transmission states is possible. In the case of three transmission states, which can each be switched on or off, eight possible combinations thus result.

In further embodiments, four, five, six, or more integer transmission states may be possible.

In a further embodiment of the optical arrangement, the wavelength-selective pulse picker has an electro-optical element. This has the advantage that it allows very short switching times in the range of a few nanoseconds up to a few hundred picoseconds. An electro-optical element is based upon the Kerr effect in a crystal and results in a wavelength-dependent rotation of the polarization of the light passing through the electro-optical element, wherein the wavelength dependency can be changed by means of the voltage applied to the electro-optical element.

In a further embodiment of the optical arrangement according to the invention, the wavelength-selective pulse picker has an acousto-optical element. An acousto-optical element also has short switching times. In contrast to the use of an electro-optical element, the switching time of an acousto-optical element depends upon the experimental conditions.

Since an acousto-optical element is based upon a sound wave which is generated and propagates in a medium, the sound velocity in the medium used and the diameter of the light beam to be modulated in the medium, inter alia, determine the switching time.

For example, when switching from a first frequency to a second frequency, the sound wave with the first frequency precedes the sound wave with the second frequency, wherein the phase front, which is located in the transition region between the first and the second frequencies, has to propagate over the entire beam diameter, until a switchover has taken place.

An acousto-optical element is also based upon the diffraction of electromagnetic waves at the acoustic wave, which forms a density grating. At the density grating, only the wavelengths that satisfy the Bragg condition are respectively diffracted.

In one embodiment of the invention, the remaining wavelengths, which are not diffracted at the density grating and thus do not reach to the sample space, can still exit from the pulse picker and be used for other applications. Conceivable applications are, for example, the illumination and generation of a Stroboscope effect, wherein the appearance of the originally broadband, preferably white-appearing light changes, depending upon the composition of the transmission states, as a result of the diffraction of individual wavelengths or wavelength ranges at the density grating.

In the simplest case, the non-diffracted light enters a beam trap and is completely absorbed in it.

In another embodiment of the optical arrangement according to the invention, the acousto-optical element has a crystal, wherein at least one sound transducer connected to the crystal is provided. With the sound transducer, which can be affixed to the crystal in a movement-transmitting manner, a sound wave is coupled into the crystal and transmitted in the crystal in a simple manner. In this case, longitudinal acoustic waves are preferably generated whose oscillation takes place in the propagation direction.

Transverse acoustic waves are also conceivable, but these generally have a lower sound velocity than longitudinal waves.

The crystal can be located between an input path into which the laser light pulses can be coupled and an output path via which the at least one laser light pulse can be decoupled towards the sample space.

The use of crystals also has the advantage that suitable cuts of the crystals can determine a propagation direction through the crystal, the optical properties of which, such as the sound velocity, are known.

At least one electro-optical element and/or at least one acousto-optical element—preferably, an acousto-optical tunable filter (AOTF)—can thus be arranged according to the invention at a location in the optical beam path that is arranged downstream, in relation to the propagation direction of the light, of the laser light source, i.e., for example, the supercontinuum laser (white light laser, WLL) or the Raman laser or a non-linear (photo-crystalline) optical fiber or a correspondingly-pulsed laser light source.

The entire disclosure contents of WO 2011/154501 A1 is included here, and all the embodiments described here also extend in this context to optical components, such as AOTF, AOM, AOD, EOM, EOD, AOBM, and AOBS, which are described in WO 2011/154501 A1 on page 2, second paragraph, to page 3, first paragraph.

Problematic with pulsed laser light sources, which emit light having several colors or wavelengths (e.g., supercontinuum lasers or Raman lasers), is that, typically, only one pulse picker for selecting the individual light pulses only for all colors can be realized at the same time, in that an electro-optical or acousto-optical element is placed between the pump light source and a non-linear fiber of a supercontinuum laser, for example. Although the functionality of the repetition rate reduction occurs, it acts simultaneously on all colors. This means, in particular, that the following configuration with a supercontinuum laser with a commercially available pulse picker, such as is known from EP 2 081 074 B1, is not possible:

Illumination with a first excitation light with a wavelength of 629 nm with a repetition rate of 40 MHz, a second excitation light with a wavelength of 485 nm with a repetition rate of 20 MHz, and a third excitation light with a wavelength of 557 nm with a repetition rate of 40 MHz, wherein the sequence of the light pulses of the second and third excitation lights is, for example, shifted in time by a predeterminable time period (e.g., 12.5 ns or 25 ns), relative to the pulse position of the first excitation light with wavelength 629 nm.

Such a temporal sequence of the first through third excitation lights would be helpful, for example, when imaging a sample provided with fluorescent dyes with the aid of a microscope and, in particular, with a scanning microscope and, very particularly preferably, with a confocal scanning microscope—in particular, for PIE—wherein the fluorescent dyes of the sample can be excited with the first through third excitation lights, and the sample is imaged or examined with the microscope or the scanning microscope or the confocal scanning microscope.

The problem can be solved in that an AOTF in which the color selection occurs by setting an oscillation frequency is controlled synchronously with the laser repetition rate with the aid of a digitally-mixed control signal, i.e., a digitally-mixed frequency sequence. The frequency sequence can preferably be generated with a digital frequency synthesizer (frequency sequence generator).

In this case, the electro-optical element and/or the acousto-optical element is/are controlled with a suitable frequency sequence which is in a predeterminable temporal relation to the repetition rate of the laser light pulses of the laser light source and is, in particular, synchronous therewith.

Such a suitable frequency sequence may be generated by means of a digital synthesizing, as described in WO 2011/154501 A1, for example.

In this case, the frequency is set alternately in a specific sequence between at least two values corresponding to the desired colors or wavelengths, and the color corresponding to the oscillation frequency currently applied to the AOTF is respectively selected per light pulse of the laser as a result of the synchronization.

In an embodiment of the optical arrangement, a control unit is provided for generating a frequency sequence for the pulse picker, wherein the transmission state of the pulse picker depends upon the frequency of the frequency sequence.

The frequency sequence can be applied to the sound transducer of the pulse picker, wherein the sound transducer oscillates at the frequency of the frequency sequence. Thus, a sound wave oscillating with this frequency propagates in the crystal and forms a density grating corresponding to the sound velocity in the material—in particular, in the crystal—with a spatial frequency that is directly proportional to the frequency of the frequency sequence.

Furthermore, in a further embodiment of the optical arrangement, the frequency sequence can have a superposition of at least two partial signals of different frequencies. This has the advantage that each frequency of the partial signals leads to a density grating of different spatial frequency. Two different wavelengths or wavelength ranges of a pulse which impinges on the pulse picker along the optical beam path can thus be switched on independently of one another.

The switching on physically corresponds to satisfying the Bragg condition, in which case light of the particular wavelength is diffracted into a predetermined direction, and an output of the pulse picker, through which the diffracted light can pass, is preferably located in this direction.

Since the light entering the pulse picker is pulsed, a spectral component selected according to a transmission state is also pulsed. The increase in pulse duration due to a reduced bandwidth is not discussed at this point, since luminescence generally has a rise time in the range of picoseconds to microseconds, and the excitation of a luminophore with a pulse duration of 10 fs thus does not differ from the excitation with a pulse duration of, for example, 300 fs.

The control unit can comprise a superposition unit, with which at least two frequencies in the frequency sequence can be superimposed. In particular, the control unit comprises a digital data processing device for generating a digital frequency sequence composed of several frequencies, and at least one digital-to-analog converter for converting the digital frequency sequence into an analog frequency sequence. The digital data processing device can in this case comprise a digital frequency calculator for calculating and generating at least two digital frequency sequence components of different frequencies. Furthermore, a digital superposition device for superimposing the at least two digital frequency sequence components and calculating the resulting digital frequency sequence can be provided in the control unit. The analog frequency sequence generated by the digital-to-analog converter can be fed into an amplifier, and amplified and transmitted by this amplifier to the sound transducer.

The control unit can be configured as a digital frequency synthesizer and may have several channels, with each of which different oscillation frequencies can be generated simultaneously and with which an electro-optical element and/or an acousto-optical element can be impinged upon simultaneously.

In a further embodiment of the optical arrangement according to the invention, the frequency sequence has a control cycle synchronized with the laser cycle. This has the advantage that the frequency sequence at the time of a laser pulse arriving in the pulse picker is not changed, and thus each laser pulse experiences a unique composition of transmission states in the open state of the pulse picker.

The frequency sequence may be pulsed.

In a further embodiment, stored, alterable illumination parameters upon which the frequency of the frequency sequence and/or the control clock depend are present in the optical arrangement. For each transmission state, the illumination parameters can thus contain a sequence which controls the switching on or off of the respective transmission state. The switching on or off may take place periodically or aperiodically at predetermined points in time corresponding to at least one cycle of the laser clock. In this case, each transmission state can have a different sequence of switching on or off.

In a further embodiment, at least one transmission state of at least two colors is present, in which the transmission spectrum has at least two wavelength maxima separated from one another. This has the advantage that luminophores whose luminescence does not influence one another (no crosstalk) can be excited simultaneously. One of the excitation wavelengths may be longer and a second of the excitation wavelengths may be shorter than an excitation wavelength of a third luminophore. Two separate wavelength maxima are advantageous if it is desired that the third luminophore not be excited together with the first or second luminophore.

In a further embodiment, the number of transmission states depends upon the number of different frequencies in the frequency sequence. Consequently, a different wavelength maximum can be assigned to each transmission state; in particular, precisely one different wavelength maximum is assigned to each transmission state.

In other words, a superposition of several sound waves is present in the pulse picker. Each of the sound waves has a different frequency, which correlates with the spatial frequency of the density grating formed. Furthermore, precisely one wavelength or wavelength range is diffracted at each density grating of a spatial frequency, viz., the one that satisfies the Bragg condition. The number of possible wavelength maxima can in this case correspond to at most the number of different frequencies in the frequency sequence.

The optical arrangement for illuminating a sample with laser pulses can comprise a pulsed laser system which emits pulses in a pulse sequence in at least two different wavelength ranges and which has a pulse trigger module for generating a trigger signal synchronized with the pulses of the laser system. Furthermore, a control unit with stored, changeable illumination parameters, and with a trigger input to which the pulse trigger module of the pulsed laser system can be connected, can be provided, wherein the control unit generates a periodically changing frequency sequence composed of at least two frequencies as a function of the stored illumination parameters and the trigger signal. The optical arrangement may further comprise an acousto-optical component having an input path, into which the light generated by the pulsed laser system can be coupled, an output path, via which the light transmitted through the acousto-optical component can be decoupled according to the illumination parameters, and a crystal connected to at least one sound transducer, wherein the frequency sequence can be applied to the sound transducer, and wherein a density grating representing the frequency sequence can be generated in the crystal using the sound transducer.

In this case, at least one sound generator can be affixed to a crystal, wherein light of the laser system can be coupled into the crystal, and is at least partially transmitted through the crystal and exits from the crystal. The control unit can transmit the frequency sequence to the at least one sound generator, and the sound generator can generate acoustic waves in the crystal as a function of the frequency sequence.

The acousto-optical component of the optical arrangement may have a propagation direction of an acoustic wave which is generated by the acousto-optical component, forms the density grating, and runs non-co-linearly to the input path. In other words, the acoustic wave and the pulses run at an angle to each other.

The optical arrangement may have at least two sound transducers attached to the crystal, wherein the thereby produced density grating may preferably be a stationary density grating. In this case, the standing wave arises upon superposition of two acoustic waves which pass through the crystal. Typically, an absorber is opposite each sound transducer in order to minimize reflections of the acoustic waves, thereby minimizing the switching time.

The density grating of the optical arrangement may have at least two spatial frequencies, wherein pulses with at least two different wavelengths may be decoupled via the output path from the acousto-optical component by diffraction at the respective spatial frequencies. The spatial frequencies may correspond to the two frequencies of the control unit.

The density grating formed in the crystal can be stationary with respect to an envelope curve of the density grating when a pulse passes through the crystal. Since the density grating in the crystal is moved, the frequency sequence composed by interference is non-stationary with respect to the crystal, but stationary with respect to the envelope curve. Synchronization between the incoming laser pulses and the density grating sections is thus possible. It is also ensured that, at the time a pulse arrives, the change in the frequency composition of the acoustic wave is already completed, and indefinite frequency states (harmonics or the like) do not occur.

The frequency sequence generated by the control unit can be divided into isochronous signal sections of respectively constant frequency composition, wherein a time duration of the signal sections can correspond to a period duration of the pulse sequence emitted by the laser system. The signal sections may be equally long (temporally), wherein the time window of a signal section may be as long as the time between two consecutive pulses.

Density grating sections of respectively constant spatial frequency composition can be generated by the sound transducer from the signal sections of respectively constant frequency composition.

Furthermore, the input path and the density grating may intersect in an interaction region, and each laser pulse passing through the interaction region may respectively pass only one density grating section.

The laser pulse may pass the density grating section substantially centrally with respect to the propagation direction of the acoustic wave.

The method for operating an optical arrangement may comprise the following steps:

generating a sequence of equidistant pulses of at least two different wavelength ranges and outputting a laser cycle synchronous with the pulse sequence;

reading illumination parameters and generating a frequency sequence by superimposing at least two frequencies as a function of the illumination parameters and the laser cycle;

transmitting the frequency sequence to a sound transducer and generating a density grating, representing the frequency sequence, in a crystal;

coupling the equidistant pulses into the crystal; and

wavelength-selective decoupling of pulses from the crystal.

The method may further comprise generating a further density grating and superimposing the density grating with the further density grating in order to generate a stationary density grating.

The time matching of signal sections of respectively equal frequency composition to a period duration of the sequence of pulses and the generating of a density grating section from the signal section may respectively be provided as further method step.

In the method, passing one pulse through, respectively, precisely one density grating section may be synchronized.

The concept is, very particularly advantageously, scalable. For example, it is possible for light pulses of four different colors (originating from the same laser light source) to either couple a pulse sequence alternating between four corresponding oscillation frequencies into the excitation beam path of a microscope, or to apply a frequency sequence with two frequencies each to the same pulse, alternating with two other frequencies for the next following pulse, depending upon the requirements of the specific application.

The freedom of digitally synthesizing any, in principle, frequency mixtures and frequency sequences also makes possible special configurations of the pulse picker, such as diffracting out two colors with each cycle of the laser clock; for the third and fourth colors, only every second pulse with appropriate time shift typical for the “PIE” method; and, for the fifth color, only every fourth pulse. The term, “color,” is to be understood as a wavelength or a wavelength range that reaches from the pulse picker to the sample space as a result of a transmission maximum. This happens as a result of diffracting or diffracting out of the acousto-optical element.

The grating changes in the acousto-optical crystal should be changed correspondingly quickly (in particular, as a function of the pulse repetition frequency of the light whose pulse repetition frequency is to be reduced) in order to allow low switching times. Helpful measures include suitable selection of the materials with high acoustic velocity. Alternatively or additionally, the optical beam diameter can be reduced until focused in the AOTF crystal. This reduces the interaction area or the interaction volume of the light to be changed with the density grating in the acousto-optical crystal or makes it possible to keep it as low as possible.

The pulse repetition frequency of the light (of at least one wavelength) whose pulse repetition frequency is to be reduced is preferably reduced in such a way that, per time interval, only a part of the original pulses can still be used in an application.

For example, in an embodiment of 100 original pulses in a time interval, only 95 to 5 pulses per time interval can still be used for an application.

Insofar as it can be represented with the synthesized frequency sequence, the latter can be used to generate virtually any sequence of pulses of different wavelengths and their predeterminable temporal sequences.

Without limiting generality, the present invention can be used for a variety of applications. In addition to the already mentioned application for microscopy, scanning microscopy, and/or confocal scanning microscopy, the optical arrangement or the method can also, in particular, be used for applications in spectroscopy.

In general, the optical arrangement or method according to the invention can be used for applications which use the light of a supercontinuum laser and/or a Raman laser and/or a light source with a non-linear (photo-crystalline) optical fiber and/or a correspondingly pulsed laser light source, and which require a predetermined sequence and/or combination of laser pulses of predetermined wavelengths.

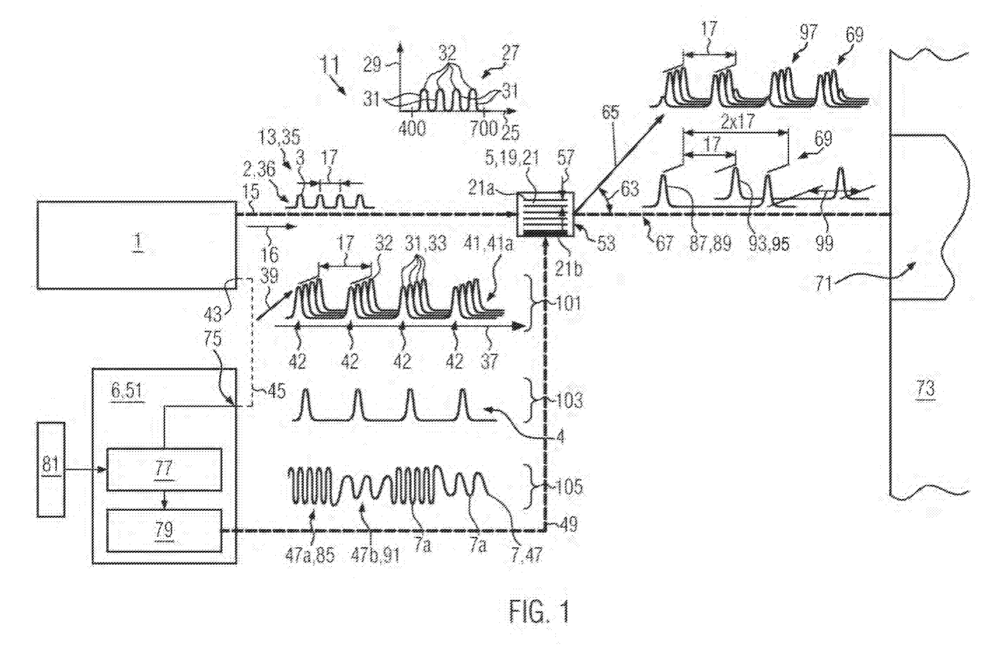

FIG. 1 shows an exemplary embodiment of the optical arrangement 11 according to the invention, comprising a laser light source 1 which generates pulsed laser light 2. The laser light 2 is shown schematically by means of a sequence 36 of four light pulses 3 propagating along an optical beam path 15. In the embodiment shown, the light pulses 3—also called laser pulses 3 or laser light pulses 3—have a pulse repetition frequency 13 of 80 MHz, wherein the pulse repetition frequency 13 corresponds to the reciprocal value of a period duration 17 and characterizes a laser cycle 35. In this laser cycle 35, the individual laser light pulses 3 are generated and emitted by the laser light source 1. In the exemplary embodiment shown, the period duration 17 has a value of 12.5 ns.

The optical beam path 15 is drawn with a dashed line, and in it is located a wavelength-selective pulse picker 19. The pulse picker 19 shown in the shown exemplary embodiment contains an acousto-optical element 21, which is designed as acousto-optical tunable filter 5, or AOTF 5 for short. The acousto-optical element 21 has a crystal 21a, to which a sound transducer 21b is attached. In other embodiments, the pulse picker 19 may be designed as electro-optical element 22.

The laser light 2 can preferably be broadband and include the visible spectral range 23, i.e., wavelengths 25 of about 400 nm to 700 nm. An exemplary spectrum 27 of the laser light 2 is shown in FIG. 1. This plots an intensity 29 of the laser light 2 over the wavelength 25. In the spectrum 27 of the laser light 2, there are four different transmission spectra 31, each assigned to a transmission state 33. Each of the transmission spectra 31 has a different wavelength maximum 32.

FIG. 1 also shows a symbolic first partial representation 101 of four transmission states 33 which repeat along a time axis 37 and are symbolized by the associated transmission spectra 31. The transmission spectra 31 are plotted along a wavelength axis 39 which extends obliquely upwards into the drawing plane (cf. the spectrum 27).

Provided with reference numerals are only four of the total of sixteen transmission states 33 or transmission spectra 31 shown and which repeat in the illumination cycle 41.

The transmission states 33 occur in one illumination cycle 41, which, in the example shown, corresponds to the laser cycle 35 and can also be referred to as control cycle 41a. In the illumination cycle 41, the AOTF 5 is in an open position 42 in each case.

In the first partial representation 101 of the embodiment of the optical arrangement 11 shown in FIG. 1 with four possible transmission states 33, a totality of the possible transmission states 33 which can be switched on or off is shown as a function of time.

In other words, these sixteen transmission states 33 are available for illumination within a period of four illumination cycles 41, i.e., four open positions 42, and can be switched on or off independently of one another in each of the open positions 42.

The transmission states 33 are thus temporarily discrete and bound to the illumination cycle 41.

The laser light source 1 has a trigger output 43 via which a generated trigger signal 4 is transmitted by means of a trigger line 45. The trigger signal 4 is shown in a second partial representation 103 and depends upon the pulse repetition frequency 13 of the laser light source 1. In particular, the frequency of the trigger signal 4 corresponds to the pulse repetition frequency 13.

The AOTF 5 is arranged in the optical path 15 downstream, in relation to the propagation direction 16 of the light 2, of the laser light source 1. The AOTF 5 is controlled by a component 6, designed as a control unit 51, which applies a frequency sequence 47 output by the control unit 51 to the AOTF 5. The signal 7 shown in a third partial representation 105 is a frequency sequence 47 and is transmitted via a control line 49 from the control unit 51 to the AOTF 5.

As a result, a corresponding oscillation wave 53 propagates in the AOTF 5 or passes through the AOTF 5, whereby a Bragg grating 55 is formed, with which the laser light 2 interacts and at which the laser light 2 is diffracted when the Bragg grating 55 has a suitable effective grating spacing 57 and a suitable propagation direction. The Bragg grating 55 is to be understood as density grating 59.

It should be noted that the orientations shown in FIG. 1 of the optical beam path upstream or downstream of the AOTF 5 with respect to the oscillation wave 53, as well as an angle 63 between a zero order 65 and a first order 67, are shown purely schematically.

In general, the optical beam path 15 is coupled into the AOTF 5 at an angle to the oscillation wave 53, the zero order 65 is not deflected by the AOTF 5, and only the first order 67 is diffracted.

The reciprocal value of the grating spacing 57 corresponds to a spatial frequency 61.

After the laser light 2 passes through the AOTF 5, at least the zero diffraction order 65 and the first diffraction order 67 of the changed light 69 thus result, which is indicated schematically in FIG. 1 to the right of the AOTF 5.

Now, the zero diffraction order 65 and/or the first diffraction order 67 of the changed light 69 could be used for an application (of a general type). In the concrete exemplary embodiment, however, only the first diffraction order 67 of the changed light 69 is used, and this changed light 69 is in fact directed towards a sample space 71 of a microscope 73 with which a sample provided with fluorescent dyes can be imaged.

The control unit 51 has a trigger input 75 into which the trigger signal 4 of the trigger output 43 of the laser light source 1 is input.

In the control unit 51, a device in the form of at least one digital frequency synthesizer 77 (frequency sequence generator) is provided, with which a digital synthesis takes place such that a suitable temporal sequence of at least one oscillation frequency 7a or frequency sequence is generated, and, in fact, as a function of the trigger signal 4. In FIG. 1, two oscillation frequencies 7a are successively combined in the frequency sequence 47.

In a frequency sequence 7, various oscillation frequencies 7a can be arrayed temporally (as in FIG. 1). Several oscillation frequencies 7a can also occur simultaneously, i.e., be superimposed.

The frequency sequence 7 thus generated is amplified with an amplifier 79 (in this example, in the form of an analog amplifier) provided in the control unit 51 and is fed to the AOTF 5 via a suitable line—the control line 49 (see dashed line). In order to generate the frequency sequence 47, the control unit 51 can read illumination parameters 81 from an illumination parameter memory and provide them to the digital frequency synthesizer 77. The frequency sequence 47 is composed of two partial signals 47a and 47b, but may also consist of more than two partial signals 47a, 47b.

In this case, the higher-frequency component 85 (indicated only schematically) of the frequency sequence 7 causes a first light pulse 87 of a pulse train having a blue color, i.e., a first wavelength 89, to respectively be diffracted into the first diffraction order 67 and thus to be fed to the microscope 73.

The other light pulse components 97 of the changed light 69 with different wavelengths of this pulse train pass through the AOTF 5 undiffracted and can be supplied to a beam trap if they are not needed for an application.

With the low-frequency component 91 of the frequency sequence 7, a second light pulse 93 having a red color, i.e., a second wavelength 95, is respectively diffracted into the first diffraction order 67 and fed to the microscope 73.

In this exemplary embodiment, every second light pulse 3 of the pulse repetition frequency 13 of the laser light 2 having a blue or red wavelength 25 is diffracted into the first diffraction order 67, wherein the diffracted out blue light pulse (the first light pulse 87) and the diffracted out red light pulse (the second light pulse 93) of the pulse repetition frequency 13 respectively originate from a different laser pulse 3 of the laser light source 1 and are therefore offset relative to one another at a time interval 99. To this extent, the light pulses 87 or 93 of the same wavelength 25 diffracted into the first diffraction order 67 respectively have a pulse spacing 99 of 25 ns, wherein a red light pulse (the second light pulse 93) follows a blue light pulse (the first light pulse 87) after 12.5 ns.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below. Additionally, statements made herein characterizing the invention refer to an embodiment of the invention and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### REFERENCE NUMERALS

1 Laser light source
2 Laser light
3 Light pulse
4 Trigger signal
5 Acousto-optical tunable filter
6 Component
7 Signal
7a Oscillation frequency
11 Optical arrangement
13 Pulse repetition frequency
15 Optical beam path
17 Period duration
19 Wavelength-selective pulse picker
21 Acousto-optical element
21a Crystal
21b Sound transducer
22 Electro-optical element
23 Visible spectral range
25 Wavelength
27 Spectrum
29 Intensity
31 Transmission spectrum
33 Transmission state
35 Laser cycle
36 Sequence
37 Time axis
39 Wavelength axis
41 Illumination cycle
41A Control cycle
42 Open position
43 Trigger output
45 Trigger line
47 Frequency sequence
49 Control line
51 Control unit
53 Oscillation wave
55 Bragg grating
57 Grating spacing
59 Density grating
61 Spatial frequency
63 Angle
65 Zero order
67 First order
69 Changed light
71 Sample space
73 Microscope
75 Trigger input
77 Digital frequency synthesizer
79 Amplifier
81 Illumination parameters
85 Higher-frequency component
87 First light pulse
89 First wavelength
91 Low-frequency component
93 Second light pulse
95 Second wavelength
97 Other light pulse component
99 Time interval
101 First partial representation
103 Second partial representation
105 Third partial representation

1. An optical arrangement having an optical beam path for illuminating a sample space with a sequence of laser light pulses generated in a laser cycle, the optical arrangement comprising:
at least one laser light source configured to generate the sequence of laser light pulses along the optical beam path; and
a wavelength-selective pulse picker situated in the optical beam path and having, in a predefined illumination clock timing synchronizable with the laser light pulses, an open state in which the pulse picker is light-transparent to at least one laser light pulse towards the sample space,
wherein the open state has at least two different transmission states which differ with regard to their respective transmission spectrums, and wherein the two transmission states are switchable on and/or off independently of one another.

2. The optical arrangement according to claim 1, wherein the pulse picker has at least three different transmission states, which are switchable independently of one another.

3. The optical arrangement according to claim 1, wherein the pulse picker has an electro-optical element.

4. The optical arrangement according to claim 1, wherein the wavelength selective pulse picker has an acousto-optical element.

5. The optical arrangement according to claim 4, wherein the acousto-optical element has a crystal, and wherein at least one sound transducer is connected to the crystal.

6. The optical arrangement according to claim 1, further comprising a control unit configured to generate a frequency sequence for the pulse picker, wherein the transmission state of the pulse picker depends upon the frequency of the frequency sequence.

7. The optical arrangement according to claim 6, wherein the frequency sequence has a superposition of at least two partial signals of different frequencies.

8. The optical arrangement according to claim 6, wherein the frequency sequence has a control cycle synchronized with the laser cycle.

9. The optical arrangement according to claim 6, wherein the frequency of the frequency sequence and/or of the control cycle depends on stored, changeable illumination parameters.

10. The optical arrangement according to claim 1, wherein at least one transmission state of at least two colors is present in which the transmission spectrum has at least two wavelength maxima separated from one another.

11. The optical arrangement according to claim 6, wherein the number of transmission states depends upon the number of different frequencies in the frequency sequence.

12. A pulsed interleaved excitation microscope comprising the optical arrangement according to claim 1.

13. A method for illuminating a sample space with a sequence of laser light pulses which are generated in a laser cycle, the method comprising:
sending the laser light pulses through a wavelength-selective pulse picker which is switched between at least two different transmission spectra synchronously with the laser cycle.

14. The method according to claim 13, wherein the switching between the at least two different transmission spectra further comprises:
generating a frequency sequence comprising at least one frequency; and
applying the frequency sequence to a sound transducer and toggling the frequency of the frequency sequence back and forth.
